(19) United States
(12) Patent Application Publication
(10) Pub. No.: US 2019/0361434 A1
(43) Pub. Date: Nov. 28, 2019

(54) SURVEILLANCE SYSTEM, UNMANNED FLYING OBJECT, AND SURVEILLANCE METHOD

(71) Applicant: NEC CORPORATION, Tokyo (JP)

(72) Inventors: Taichi OHTSUJI, Tokyo (JP); Kazushi MURAOKA, Tokyo (JP); Hiroaki AMINAKA, Tokyo (JP); Dai KANETOMO, Tokyo (JP); Norio YAMAGAKI, Tokyo (JP); Takashi YOSHINAGA, Tokyo (JP)

(73) Assignee: NEC CORPORATION, Tokyo (JP)

(21) Appl. No.: 16/472,633

(22) PCT Filed: Feb. 27, 2017
(86) PCT No.: PCT/JP2017/007289

§ 371 Date: Jun. 21, 2019

Related U.S. Application Data
(60) Provisional application No. 62/437,779, filed on Dec. 22, 2016.

(51) Int. Cl. G05D 1/00; G05D 1/10; G05D 1/12; B64C 39/02

(52) U.S. Cl. CPC G05D 1/0027; G05D 1/0094; G05D 1/101; G05D 1/12; B64D 47/08; B64C 2201/027; B64C 2201/127; B64C 2201/146; B64C 39/024

(57) ABSTRACT

A surveillance system includes an unmanned flying object information management part configured to store information on each of a plurality of unmanned flying objects including a predetermined flying pattern of each of the unmanned flying objects, each of the unmanned flying objects including a surveillance apparatus and being configured to move in the predetermined flying pattern; an unmanned flying object selection part configured to select at least one of the unmanned flying objects to which the surveillance of a surveillance target is requested, based on a predetermined switching condition and information received from each of the unmanned flying objects; and a surveillance instruction part configured to instruct the selected unmanned flying object(s) to surveil the surveillance target by transmitting identification information of the surveillance target to the selected unmanned flying object(s).

### CROSS-REFERENCE TO RELATED APPLICATIONS

This Application is a National Stage of International Application No. PCT/JP2017/007289 filed Feb. 27, 2017, claiming priority based on U.S. Provisional Application No. 62/437,779 (filed on Dec. 22, 2016), the disclosure of which is incorporated herein in its entirety by reference.

### FIELD

The present invention relates to a surveillance system, an unmanned flying object, and a surveillance method. More specifically, the invention relates to a surveillance system, an unmanned flying object, and a surveillance method for surveilling a moving surveillance target.

### BACKGROUND

Patent Literature (PTL) 1 discloses a configuration in which a position of a surveillance target is constantly checked by tracking the surveillance target by a drone apparatus.

Patent Literature 2 discloses a system for autonomously tracking a moving target from UAVs (unmanned aerial vehicles) with a variety of airframe and sensor payload capabilities so that the target remains within the vehicle's sensor field of view regardless of the specific target motion patterns. Specifically, the system described in the publication is described to have a tracking mode in which the target is kept within the sensor field of view.

Patent Literature 3 discloses an analytic system in which using an unmanned aerial vehicle (drone), a short-distance radio wave of a user terminal is detected from the sky, and the position of the user terminal is thereby identified. According to this analytic system, action information of a user in a wide range including outdoors can be collected with high accuracy, using position information that has been obtained, and user attribute information can be concretely analyzed.

Patent Literature 4 discloses a configuration in which by appropriately providing, to a plurality of sensors capable of changing orientations of the sensors, target track and orientation change instructions, a larger number of targets can be simultaneously tracked using a smaller number of the sensors.
[PTL 1]
JP Patent Kokai Publication No. JP-P-2015-207149A
[PTL 2]
JP Patent Kokai Publication No. JP-P-2009-173263A
[PTL 3]
JP Patent No. 6020872
[PTL 4]
JP Patent Kokai Publication No. JP-P-2011-185723A

### SUMMARY

Assume that a surveillance target person is surveilled using an unmanned flying object (hereinafter, a drone, an unmanned aerial vehicle, and so on will be herein collectively referred to as “unmanned flying object(s)”), Then, if the configuration as in any of Patent Literatures 1 and 2, in which the drone apparatus tracks the surveillance target person is employed, the surveillance target person may perceive that he is being surveilled, so that he may take an action of disappearing from the field of view or may take an unintended action, thereby hindering a proper surveillance operation.

On contrast therewith, Patent Literature 3 discloses collection of the information on the position of the user terminal. This analytic system, however, has a constraint that the user must possess the terminal and that terminal must be an apparatus configured to emit the short distance radio wave.

In the method in Patent Literature 4, there is a problem that fixed type sensors are used, so that a surveillance target person cannot be tracked if he does not enter into an area where these sensors are disposed.

It is an object of the present invention to provide a surveillance system, an unmanned flying object, and a surveillance method that make it difficult for a surveillance target person to perceive that he is under surveillance while using the unmanned flying object (or entity).

According to a first aspect, there is provided a surveillance system comprising:

an unmanned flying object (entity) information management part configured to store information, on each of a plurality of unmanned flying objects, including a predetermined flying pattern of each of the unmanned flying objects, each of the unmanned flying objects including a surveillance apparatus and being configured to move in the predetermined flying pattern;

an unmanned flying object selection part configured to select at least one of the unmanned flying objects to which surveillance of a surveillance target is requested, based on a predetermined switching condition and information received from each of the unmanned flying objects; and

a surveillance instruction part configured to instruct the selected unmanned flying object(s) to surveil the surveillance target by transmitting identification information of the surveillance target to the selected unmanned flying object(s).

According to a second aspect, there is provided an unmanned flying object comprising a surveillance apparatus configured to surveil a surveillance target based on an instruction from the surveillance system and transmit information on the surveillance target.

According to a third aspect, there is provided a surveillance method performed by a computer, wherein the computer comprises comprising an unmanned flying object information management part configured to store information on each of a plurality of unmanned flying objects including a predetermined flying pattern of each of the unmanned flying objects, each of the unmanned flying objects including a surveillance apparatus and being configured to move in the predetermined flying pattern, the computer performing processing comprising:

selecting at least one of the unmanned flying objects to which surveillance of a surveillance target is to be requested, based on a predetermined switching condition and information received from the unmanned flying object(s); and

instructing the selected unmanned flying object(s) to surveil the surveillance target by transmitting identification information of the surveillance target to the selected unmanned flying object(s). This method is linked to a specific machine that is the computer configured to instruct the unmanned flying object(s) to surveil the surveillance target.

According to a fourth aspect, there is provided a program configured to cause a computer comprising an unmanned flying object information management part configured to store information, on each of a plurality of unmanned flying objects, including a predetermined flying pattern of each of the unmanned flying objects, each of the unmanned flying objects including a surveillance apparatus and being configured to move in the predetermined flying pattern, to perform processings comprising:

selecting at least one of the unmanned flying objects to which surveillance of a surveillance target is to be requested, based on a predetermined switching condition and information received from the unmanned flying object(s); and

instructing the selected unmanned flying object(s) to surveil the surveillance target by transmitting identification information of the surveillance target to the selected unmanned flying object(s). This program can be recorded in a computer-readable (non-transient) storage medium. That is, the present invention can also be embodied as a computer program product.

According to the present invention, the surveillance by the unmanned flying object can be performed in a manner configuration that is difficult to be perceived by a surveillance target person.

### BRIEF DESCRIPTION OF DRAWINGS

FIG. 1 is a diagram illustrating a configuration of one exemplary embodiment of the present invention.

FIG. 2 is a diagram for explaining operations in the one exemplary embodiment of the present invention.

FIG. 3 is a diagram illustrating a configuration of a surveillance system in a first exemplary embodiment of the present invention.

FIG. 4 is a diagram illustrating a configuration of an unmanned aerial vehicle in the first exemplary embodiment of the present invention.

FIG. 5 is a diagram illustrating a configuration of a management server in the first exemplary embodiment of the present invention.

FIG. 6 is a table illustrating an example of unmanned aerial vehicle information that is held in the management server in the first exemplary embodiment of the present invention.

FIG. 7 is a table illustrating an example of surveillance target information that is held in the management server in the first exemplary embodiment of the present invention.

FIG. 8 is a flow diagram illustrating operations of the unmanned aerial vehicle (in an information transmission process to the management server) in the first exemplary embodiment of the present invention.

FIG. 9 is a flow diagram illustrating operations of the unmanned aerial vehicle (in an instruction reception process from the management server) in the first exemplary embodiment of the present invention.

FIG. 10 is a flow diagram illustrating operations of the management server in the first exemplary embodiment of the present invention.

FIG. 11 is a sequence diagram illustrating overall operations of the first exemplary embodiment of the present invention.

FIG. 12 is a diagram illustrating an example of a moving path of a surveillance target.

FIG. 13 shows diagrams illustrating examples of selecting the unmanned aerial vehicle for surveilling the surveillance target in FIG. 12.

FIG. 14 is a diagram illustrating an example of a control screen that is provided by the management server in the first exemplary embodiment of the present invention.

FIG. 15 is a sequence diagram illustrating operations of a second exemplary embodiment of the present invention.

FIG. 16 is a sequence diagram illustrating operations of a third exemplary embodiment of the present invention.

FIG. 17 is a sequence diagram illustrating operations of a surveillance system according to an exemplary embodiment.

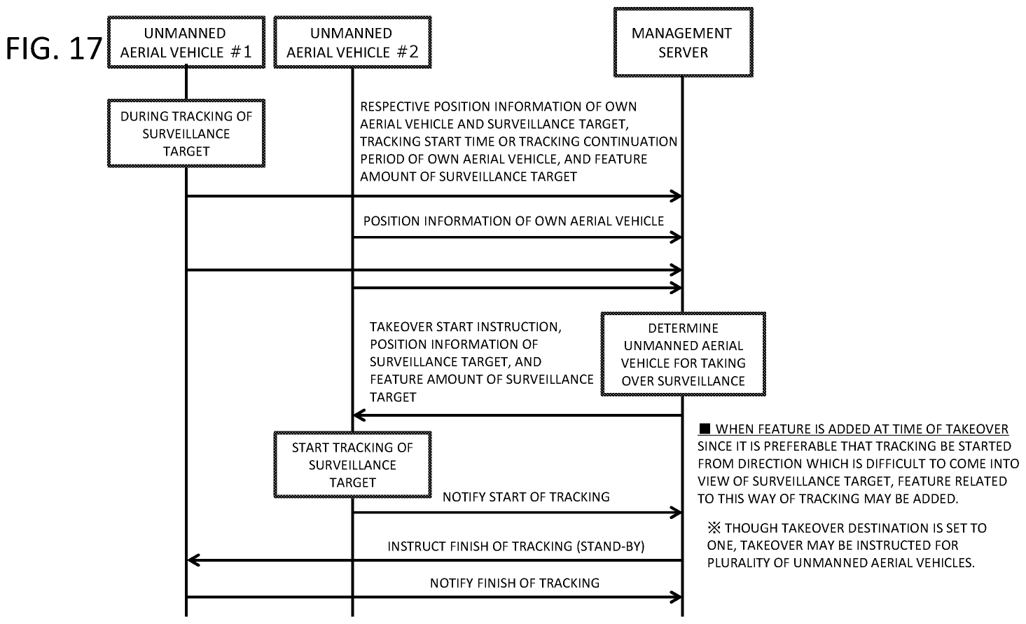

FIG. 18 is an operation flowchart of an unmanned aerial vehicle according to an exemplary embodiment.

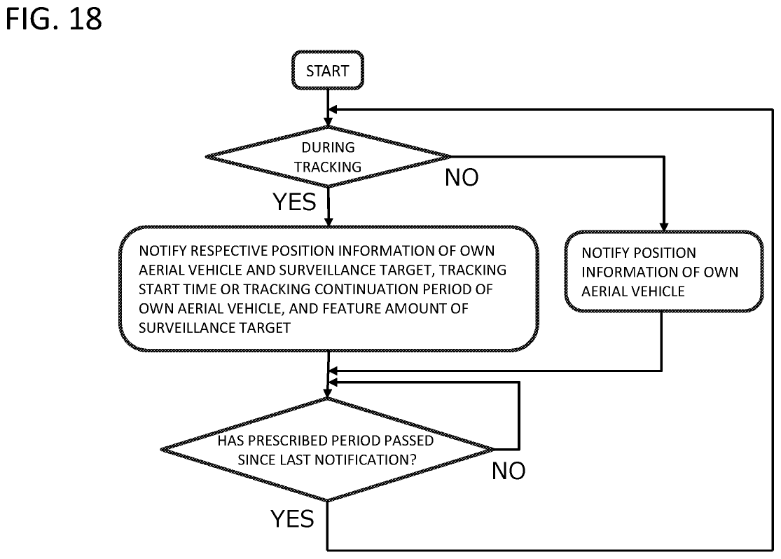

FIG. 19 is another operation flowchart of an unmanned aerial vehicle according to an exemplary embodiment.

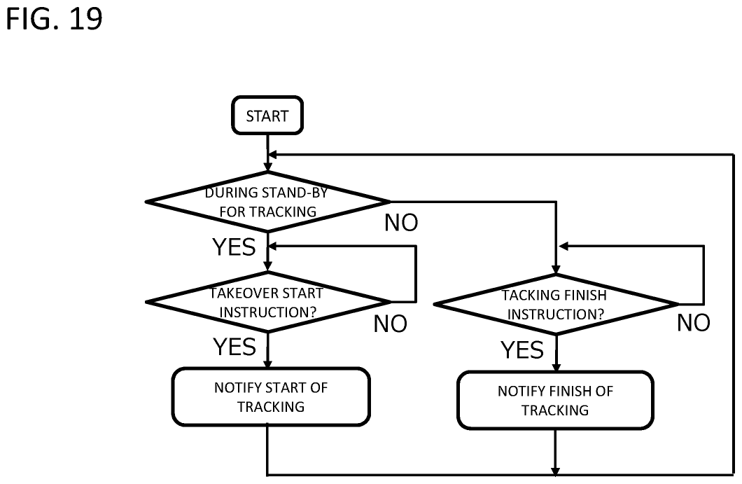

FIG. 20 is an operation flowchart of a management server according to an exemplary embodiment.

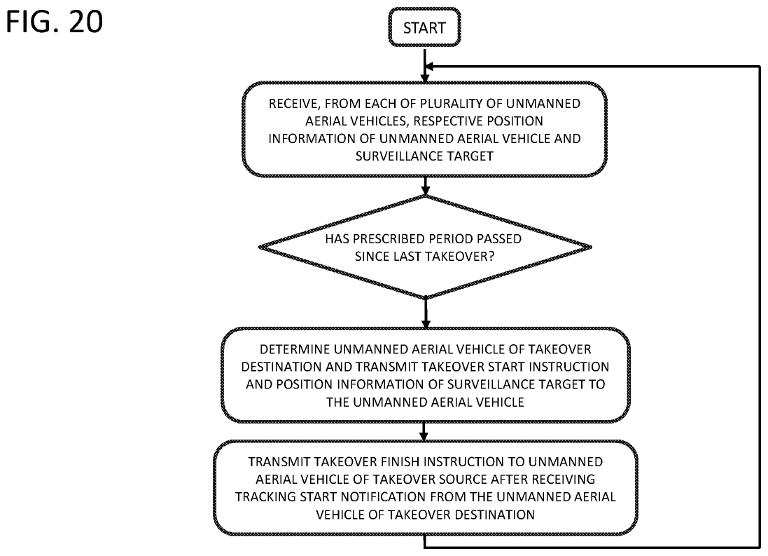

FIG. 21 is a functional block diagram of an unmanned aerial vehicle according to an exemplary embodiment.

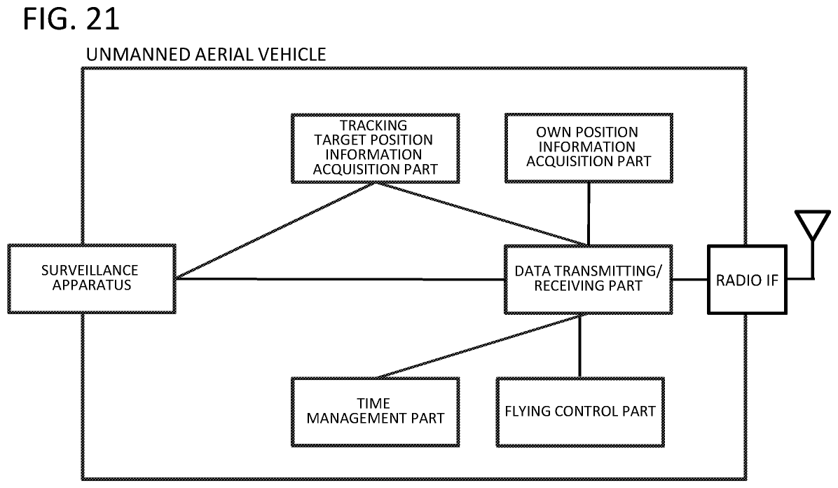

FIG. 22 is a functional block diagram of a management server according to an exemplary embodiment.

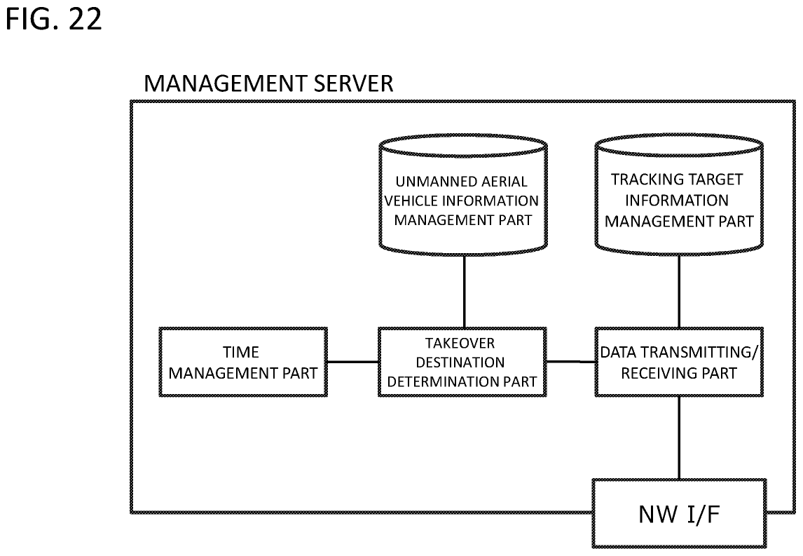

FIG. 23 is a sequence diagram illustrating different operations of a surveillance system according to an exemplary embodiment.

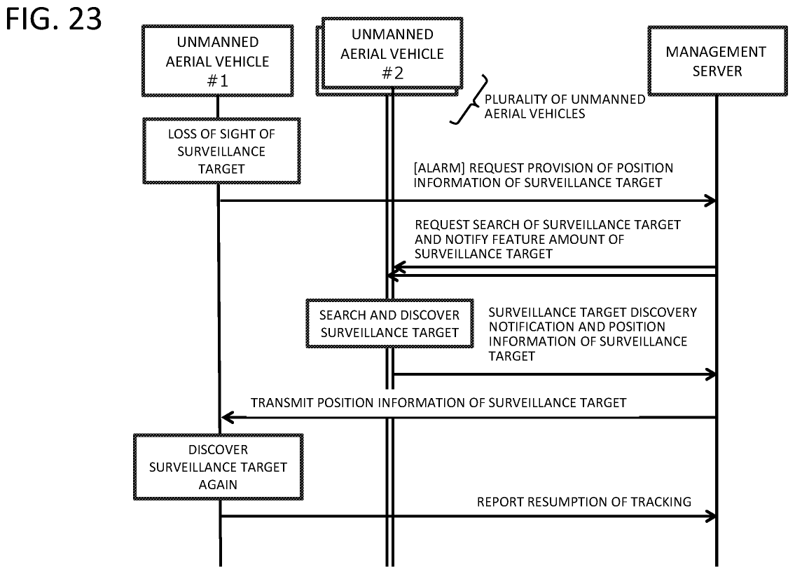

FIG. 24 is a sequence diagram illustrating different operations of a surveillance system according to an exemplary embodiment.

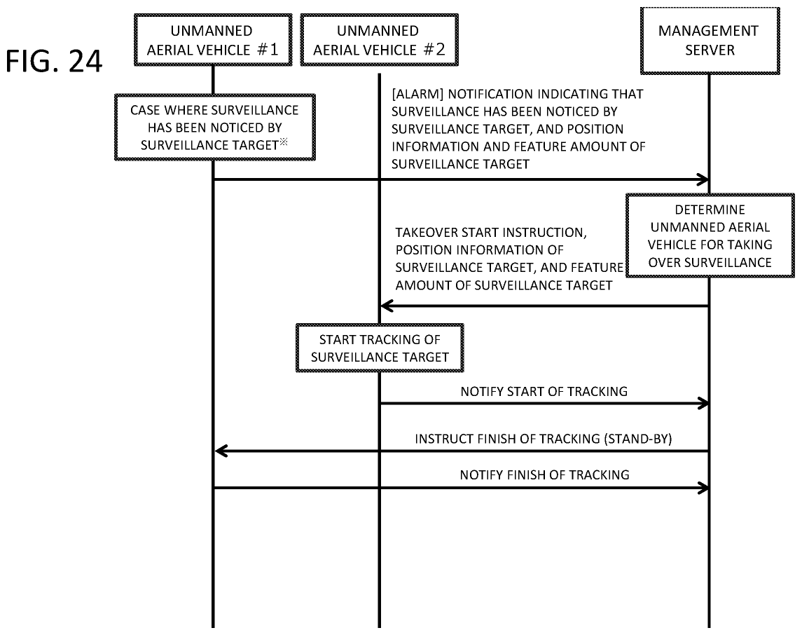

FIG. 25 is a block diagram illustrating a configuration of an information processing apparatus according to an exemplary embodiment.

### PREFERRED MODES

First, an overview of one exemplary embodiment of the present invention will be described with reference to the drawings. A reference numeral in each drawing given in this overview is provided to each element for convenience as an example for helping understanding, and does not intend to limit the present invention to the modes that have been illustrated. Connection lines between blocks in the drawings to be used in the following description include bidirectional connection lines and monodirectional connection lines. Each monodirectional arrow schematically illustrates a main signal (data) flow and does not exclude bidirectionality.

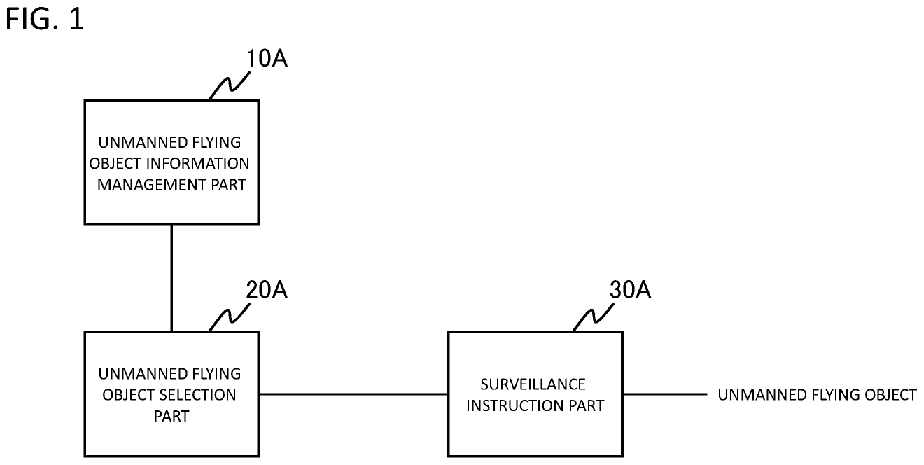

As illustrated in FIG. 1, in one exemplary embodiment, the present invention can be implemented by a surveillance system including an unmanned flying object information management part 10A, an unmanned flying object selection part 20A, and a surveillance instruction part 30A.

The unmanned flying object information management part 10A stores information, on a plurality of unmanned flying objects, including a predetermined flying patterns of each of the unmanned flying objects, each of the unmanned flying objects including a surveillance apparatus and being configured to move in the predetermined flying pattern.

The unmanned flying object selection part 20A selects at least one of the unmanned flying objects to which surveillance of a surveillance target is requested, based on a predetermined switching condition and information received from the unmanned flying objects.

The surveillance instruction part 30A instructs the selected unmanned flying object(s) to surveil the surveillance target by transmitting identification information of the surveillance target.

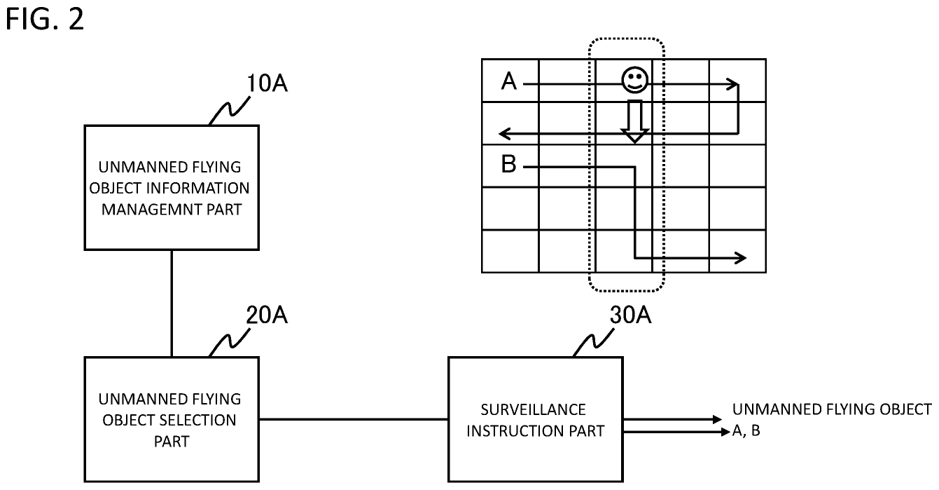

A description will be given about movement of the surveillance target and an operation of selecting the unmanned flying object, using a 5×5 grid on the upper right of FIG. 2. To take an example, the surveillance target is assumed to have moved from a coordinate (3, 1) to a coordinate (3, 5), as illustrated on the upper right of FIG. 2. Further, an unmanned flying object A is assumed to move in a flying pattern in which the unmanned flying object A goes from a coordinate (1, 1) to a coordinate (5, 1), and then moves to a coordinate (1, 2) via a coordinate (5, 2). Further, an unmanned flying object B is assumed to move in a flying pattern in which the unmanned flying object B goes from a coordinate (1, 3) to a coordinate (3, 3), and then moves to a coordinate (5, 5) via a coordinate (3, 5).

In this case, the unmanned flying object selection part 20A selects the unmanned flying object A as a subject for performing surveillance during movement of the surveillance target from the coordinate (3.1) to the coordinate (3.2), based on a distance between the surveillance target and the unmanned flying object. Similarly, the unmanned flying object selection part 20A selects the unmanned flying object B as a subject for performing surveillance during movement of the surveillance target from the coordinate (3.2) to the coordinate (3.5), based on a distance between the surveillance target and each unmanned flying object. Then, the surveillance instruction unit 30A transmits, to each of the selected unmanned flying objects A and B, identification information of the surveillance target, thereby requesting the surveillance of the surveillance target.

As mentioned above, according to the present invention, it becomes possible to perform the surveillance by the unmanned flying object in a manner configuration that is difficult to be noticed by the surveillance target. The reason for that is the configuration is employed where the surveillance of the surveillance target is appropriately requested by selecting an unmanned flying object flying near the surveillance target, without requesting tracking of the surveillance target to the unmanned flying object to which the surveillance is requested.

The selection operation of the unmanned flying object selection part 20A can be implemented by predicting movement of the surveillance target and movements of the unmanned flying objects, and selecting a nearest unmanned flying object at each point of time. Naturally, on that occasion, it is also possible to make comprehensive determination, in consideration of performance (such as the resolution of the surveillance apparatus, the flyable time length, the flying speed, and the silence property) of each unmanned flying object, a battery residual quantity, a period of time of the surveillance to be made by a same unmanned flying object, and so on.

### First Exemplary Embodiment

Subsequently, a first exemplary embodiment of the present invention will be described in detail with reference to the drawings.

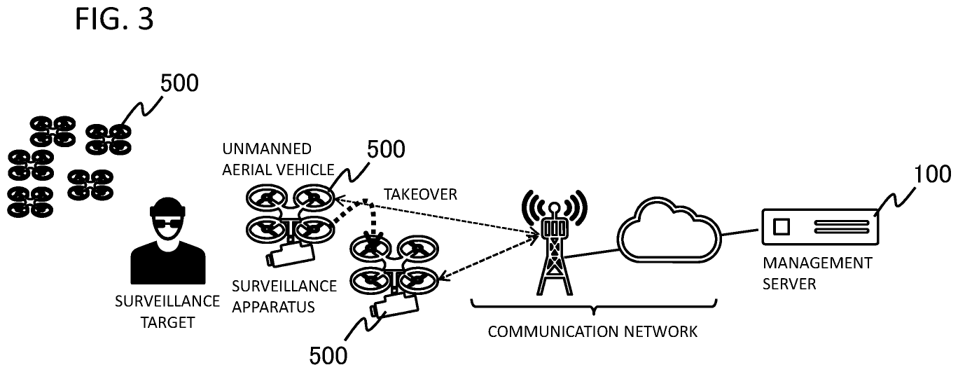

FIG. 3 is a diagram illustrating a configuration of a surveillance system in the first exemplary embodiment of the present invention. Referring to FIG. 3, the configuration is illustrated in which a management server 100 and a plurality of unmanned aerial vehicles (also referred to as drones) 500 are connected via a communication network. In this embodiment, with the above-mentioned configuration, a plurality of the unmanned aerial vehicles surveil a surveillance target while performing takeover, based on an instruction from the management server 100. Each unmanned aerial vehicle 500 is an aircraft on which a surveillance apparatus is mounted and which can be autonomously driven, and corresponds to the above-mentioned unmanned flying object (entity). The surveillance target may be a person, or a mobile object such as a vehicle or a robot.

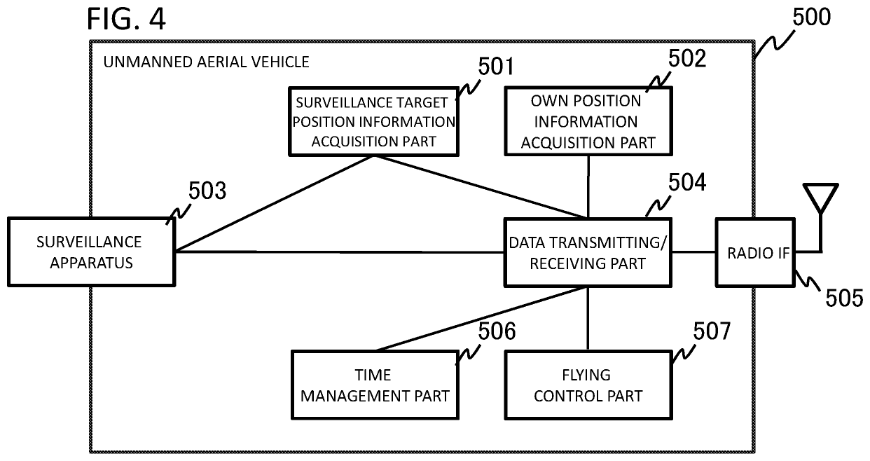

FIG. 4 is a diagram illustrating a configuration of the unmanned aerial vehicle 500 in the first exemplary embodiment of the present invention. Referring to FIG. 4, the configuration including a surveillance target position information acquisition part 501, an own position information acquisition part 502, a surveillance apparatus 503, a data transmitting/receiving part 504, a radio interface (hereinafter referred to as an “radio IF”) 505, a time management part 506, and a flying control part 507 is illustrated.

The surveillance target position information acquisition part 501 acquires information of a position (relative position from an own aerial vehicle) of the surveillance target based on a video (or image) obtained from the surveillance apparatus 503 and transmits the position information to the data transmitting/receiving part 504. A method of acquiring the position information is not limited to a method of directly acquiring the position information by the unmanned aerial vehicle 500, such as a method of acquiring the orientation of and a distance from the surveillance target or a method of using a distance sensor, based on the video obtained from the surveillance apparatus 503. To take example, it is also possible to employ a method of transmitting the video obtained from the surveillance apparatus 503 or information for identifying the surveillance target to a network side via the data transmitting/receiving part 504 and acquiring the information of the position that has been identified, on the network side. As such a method of indirectly acquiring the position information, a method of using position information of a terminal possessed by the surveillance target or a different tracking system service may be considered.

The own position information acquirement part 502 performs positioning, using a satellite positioning system such as a GPS (Global Positioning System), thereby acquiring position information indicating the position of the own aerial vehicle.

The surveillance apparatus 503 is an imaging apparatus for surveilling the surveillance target, and a camera that is commonly included in the unmanned aerial vehicle 500 or the like can be used for the surveillance apparatus 503. In this exemplary embodiment, the video or an image of the surveillance target that has been photographed by the surveillance apparatus 503 is transmitted to the management server 100 via the data transmitting/receiving part 504.

The data transmitting/receiving part 504 communicates with the management server 100 via the radio IF 505. Specifically, the data transmitting/receiving part 504 transmits, to the management server 100, the position information of the own aerial vehicle. Alternatively, during the surveillance, the data transmitting/receiving part 504 transmits the position information of the own aerial vehicle and the position information of the surveillance target, feature information of the surveillance target, a period of time after a start of the surveillance (or a surveillance start time), and so on. When the data transmitting/receiving part 504 receives an instruction from the management server 100, the data transmitting/receiving part 504 transmits the instruction to the surveillance apparatus 503.

The time management part 506 holds a clocking device (timer) and records a time at which the surveillance has been started, a period of time during which the surveillance has been continued, and so on, for management.

The flying control part 507 moves the unmanned aerial vehicle 500 according to a preset flying pattern or a remote instruction from a user. When the unmanned aerial vehicle 500 is an unmanned aerial vehicle of a multicopter type including a plurality of rotors, for example, the flying control part 507 controls these rotors, thereby moving the unmanned aerial vehicle 500 along an intended course.

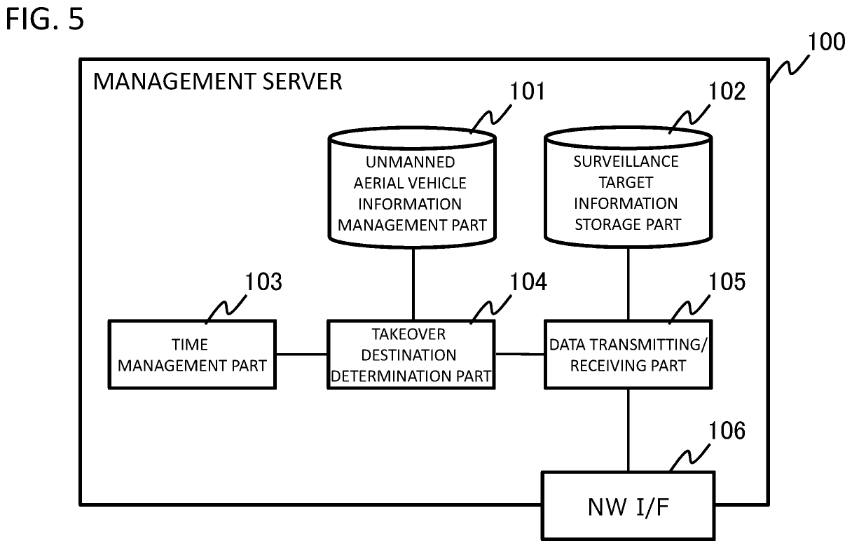

Subsequently, a configuration of the management server 100 configured to provide instructions to the above-mentioned unmanned aerial vehicle 500 will be described. FIG. 5 is a diagram illustrating the configuration of the management server 100 in the first exemplary embodiment of the present invention. Referring to FIG. 5, the configuration including an unmanned aerial vehicle information management part 101, a surveillance target information storage part 102, a time management part 103, a takeover destination determination part 104, a data transmitting/receiving part 105, and a radio interface (hereinafter referred to as a “radio IF”) 106 is illustrated.

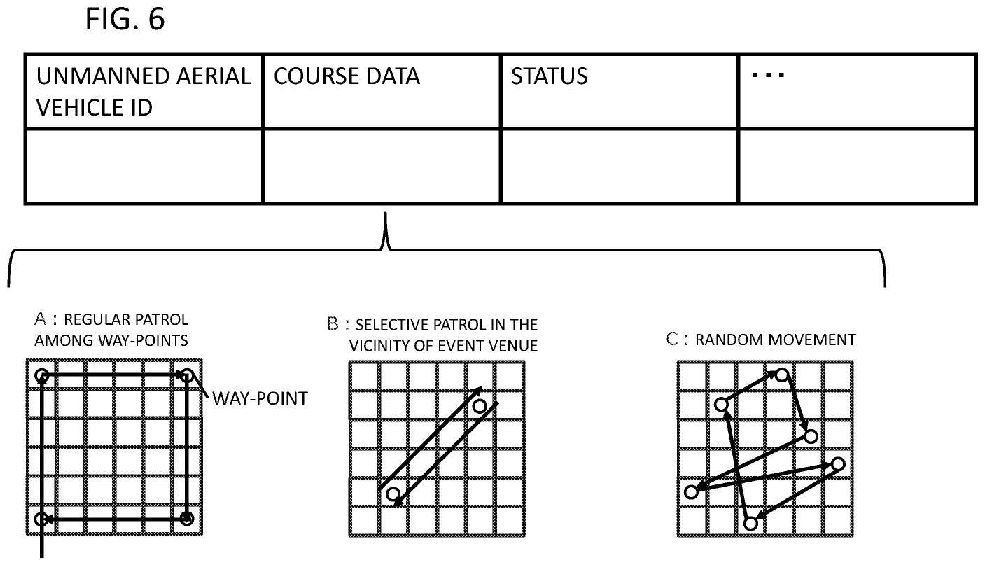

The unmanned aerial vehicle information management part 101 manages information on one or more unmanned aerial vehicles for which the surveillance of the surveillance target can be requested. FIG. 6 is a table illustrating an example of the information on the one or more unmanned aerial vehicles that is held by the unmanned aerial vehicle information management part 101. The example in FIG. 6 illustrates the information on the one or more unmanned aerial vehicles in which course data (flying pattern) of each unmanned aerial vehicle that is identified by an unmanned aerial vehicle ID and other status information of the aerial vehicle are associated (i.e., listed in corresponding each other). In the field of the course data, information indicating a flying pattern, such as a patrol through or among way-points, a patrol between specific points, or random movement to move as required upon anytime receiving an instruction, which has been instructed to the unmanned aerial vehicle 500 is stored, as illustrated in the lower stage of FIG. 6. As the status information, information necessary for selecting the unmanned aerial vehicle(s) for surveilling the surveillance target is stored. To take an example, a battery state of each unmanned aerial vehicle, a flyable distance, whether the unmanned aerial vehicle is in a state capable of accepting an instruction to surveil the surveillance target, and so on are stored as the status information. As the other information on the one or more unmanned aerial vehicles, performance (such as the highest speed, the achievable altitude, the weight, and so on) of each unmanned aerial vehicle, fields of use or application, owner and an operator, specifications (such as the number of pixels, the focal distance, the lens magnification, the dynamic range, presence or absence of directionality) of the surveillance apparatus, a communication speed (such as the theoretically maximum speed or the expected throughput) of the radio IF, and so on may be stored in the form of attribute information of each aerial vehicle. Preferably, contents (stored information) of the above-mentioned unmanned aerial vehicle information management part 101 are updated at an appropriate timing, based on a notification from the operator of each unmanned aerial vehicle.

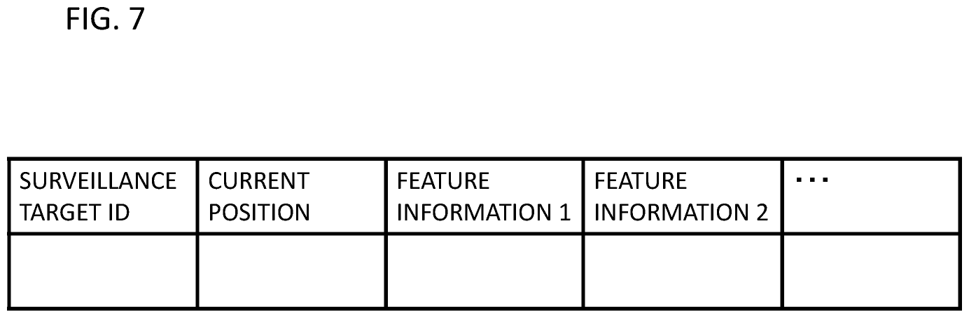

Information on a person, a vehicle, or the like to be surveilled is stored in the surveillance target information storage part 102. FIG. 7 is a table illustrating an example of surveillance target information held (stored) by the surveillance target information storage part 102. In the example in FIG. 7, position information of each surveillance target that is identified by a surveillance target ID and at least one feature information are set. Preferably, features capable of being identified by the surveillance apparatus of each unmanned aerial vehicle 500, such as clothes, hair and skin colors, height of body, the gender and so on of a person to be surveilled, for example, are employed as the feature information. Information capable of being used as the feature information is not limited to the appearance features of the surveillance target as mentioned above. If the unmanned aerial vehicle 500 can identify a terminal ID that is transmitted wirelessly by the terminal or the like held by the surveillance target, sound voice (voice feature), language, or the like, the surveillance target can also be identified, using these pieces of information.

The time management part 103 holds a clocking device (timer), records a surveillance start time, a surveillance continuation period, and so on of each unmanned aerial vehicle 500, for management.

The takeover destination determination part 104 determines the unmanned aerial vehicle for newly starting the surveillance, in place of the unmanned aerial vehicle 500 that is surveilling the surveillance target, at a predetermined occurrence (or moment). More specifically, the takeover destination determination part 104 selects an unmanned aerial vehicle(s) for newly starting the surveillance, based on the information on the surveillance target held in the surveillance target information storage part 102 and the unmanned aerial vehicle information management part 101. It may be so configured that using the following information as selection criteria of the unmanned aerial vehicle, that is, the unmanned aerial vehicle having a highest score from comprehensive (overall) viewpoint is selected from among the plurality of unmanned aerial vehicles. The information to be used as the selection criteria may include a period during which the surveillance target can be surveilled or a period during which the surveillance target is held in a photographable range of the surveillance apparatus, a flyable distance of the unmanned aerial vehicle or a battery residual quantity of the unmanned aerial vehicle, whether or not the unmanned aerial vehicle has specifications (such as the altitude and noise during flying) that are difficult to be noticed by the surveillance target, whether or not the unmanned aerial vehicle occupies a position (typically, at the back of the surveillance target) that is difficult to be noticed by the surveillance target, and so on, in addition to that the unmanned aerial vehicle is the one that is capable of surveilling the surveillance target using the mounted surveillance apparatus.

The data transmitting/receiving part 105 transmits a surveillance instruction to an unmanned aerial vehicle 500 to newly start the surveillance and instructs an unmanned aerial vehicle 500 that will finish the surveillance to finish the surveillance, via the network IF (NW I/F) 106. The data transmitting/receiving part 105 receives the feature information of the surveillance target, position information of the unmanned aerial vehicle 500 and position information of the surveillance target, the surveillance continuation period, and so on that have been transmitted from the unmanned aerial vehicle 500, via the radio IF 106.

Each part (processing means) of the unmanned aerial vehicle 500 and the management server 100 illustrated in FIGS. 4 and 5 can also be implemented by a computer program configured to a cause a processor mounted on each of these apparatuses to execute each process described above by using hardware of the processor(s).

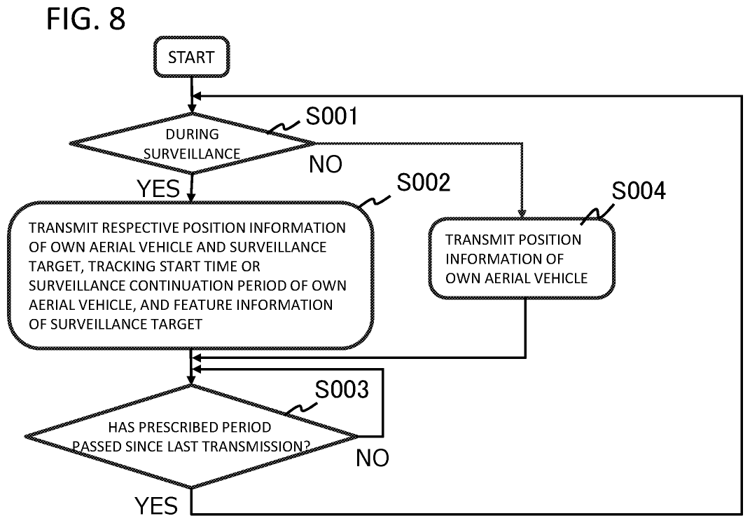

Subsequently, operations of this exemplary embodiment will be described in detail, with reference to the drawings. First, a description will be given about an information transmission process to the management server by (each) the unmanned aerial vehicle 500. FIG. 8 is a flow diagram illustrating operations of (each) the unmanned aerial vehicle (in the information transmission process to the management server) in the first exemplary embodiment of the present invention. Referring to FIG. 8, if a surveillance target is under surveillance (YES in step S001), the unmanned aerial vehicle 500 transmits position information of an own aerial vehicle and position information of the surveillance target, the surveillance start time or the tracker (surveillance) continuation period of the own aerial vehicle, and feature information of the surveillance target (step S002).

Then, the unmanned aerial vehicle 500 checks whether or not a prescribed period has passed since the unmanned aerial vehicle 500 performed last transmission to the management server 100 (step S003). If the prescribed period has not passed, the unmanned aerial vehicle 500 continues the checking operation (stand-by for transmission) in step S003. On the other hand, if the prescribed period has passed, the unmanned aerial vehicle 500 returns to step S001 in order to transmit new information to the management server 100.

If it has been determined in step S001 that the surveillance target is not under surveillance (NO in step S001), the unmanned aerial vehicle 500 transmits the position information of the own aerial vehicle to the management server 100 (step S004).

As mentioned above, the unmanned aerial vehicle 500 transmits, to the management server 100, the information necessary for surveillance of the surveillance target and takeover thereof at predetermined time intervals.

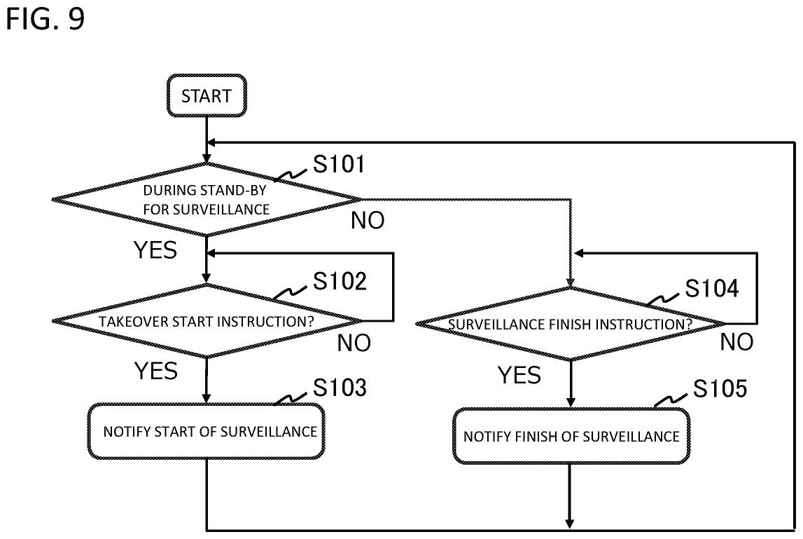

Then, a description will be given about operations of the (each) unmanned aerial vehicle 500 when the unmanned aerial vehicle 500 has received an instruction from the management server. FIG. 9 is a flow diagram illustrating the operations of the unmanned aerial vehicle (in an instruction reception process from the management server) in the first exemplary embodiment of the present invention. Referring to FIG. 9, during stand-by of the unmanned aerial vehicle 500 for the surveillance or when the unmanned aerial vehicle 500 is not surveilling the surveillance target (YES in step S101), the unmanned aerial vehicle 500 starts the surveillance of the surveillance target if the unmanned aerial vehicle 500 has received, from the management server 100, a surveillance takeover instruction for the surveillance target (YES in step S102). Then, the unmanned aerial vehicle 500 notifies start of the surveillance to the management server 100 (step S103).

On the other hand, during the surveillance of the unmanned aerial vehicle 500, that is, when the unmanned aerial vehicle 500 is surveilling the surveillance target (NO in step S101), the unmanned aerial vehicle 500 finishes the surveillance of the surveillance target if the unmanned aerial vehicle 500 has received a surveillance finish instruction for the surveillance target (YES in step S104). Then, the unmanned aerial vehicle 500 notifies the finish of the surveillance to the management server 100 (step S105).

As mentioned above, the unmanned aerial vehicle 500 starts or finish the surveillance of the surveillance target according to the instruction from the management server 100 and notifies start or finish of the surveillance of the surveillance target to the management server 100.

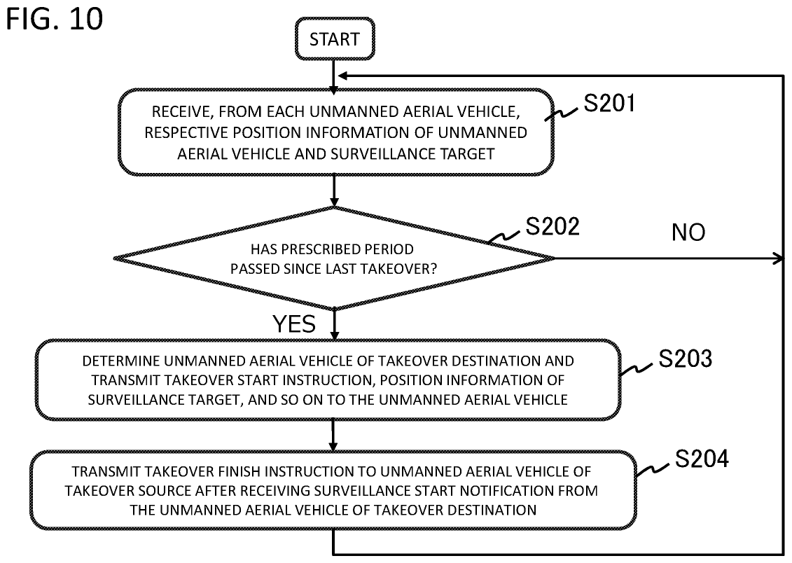

Subsequently, an operation of transmitting an instruction to the unmanned aerial vehicle by the management server 100 will be described. FIG. 10 is a flow diagram illustrating operations of the management server 100 in the first exemplary embodiment of the present invention. Referring to FIG. 10, the management server 100 first receives the position information of each unmanned aerial vehicle and the position information of the surveillance target from the unmanned aerial vehicle that performs the operations in FIG. 8 (step S201).

Then, the management server 100 checks whether or not a prescribed period has passed since takeover was last performed, or whether the surveillance by a certain unmanned aerial vehicle has passed the prescribed period (step S202).

If the surveillance by an unmanned aerial vehicle has passed the prescribed period after a result of the check (YES in step S202), the management server 100 determines the unmanned aerial vehicle of a takeover destination, and transmits, to this unmanned aerial vehicle, a takeover start instruction, and the position information and the feature information of the surveillance target (step S203).

If the management server 100 has received the above-mentioned surveillance start notification from the unmanned aerial vehicle of the takeover destination, the management server 100 transmits a takeover finish instruction to the unmanned aerial vehicle of a takeover source (step S204).

If the surveillance by a certain unmanned aerial vehicle has not passed a prescribed period in step S202 (NO in step S202), the flow returns to step S201 and continues receiving new information from any unmanned aerial vehicle 500.

As mentioned above, the management server 100 performs an operation of switching-over the unmanned aerial vehicles 500 for surveilling the surveillance target, for each prescribed period. The “prescribed period” in the above-mentioned step S202 does not need to be a fixed period. To take an example, a period that is determined using a random number is added to a certain period, and a resultant value may be used as the prescribed period. That is, using the period that is randomly determined for each time of switching of the unmanned aerial vehicles 500, the unmanned aerial vehicle to perform the surveillance may be switched-over. This makes it possible to reduce a possibility that the surveillance target may notice the surveillance. It may be so configured that the prescribed period is determined in consideration of whether the surveillance is in a condition that is easy to be noticed by the surveillance target in terms of the attribute of the surveillance target (typically, whether or not the surveillance target is a terrorist or a criminal (who is cautious) or the like), a time zone, a climate condition of a surveillance target area, the number of the unmanned aerial vehicles that are present around (neighboring) the surveillance target), and so on, for example, rather than by randomly changing the prescribed period.

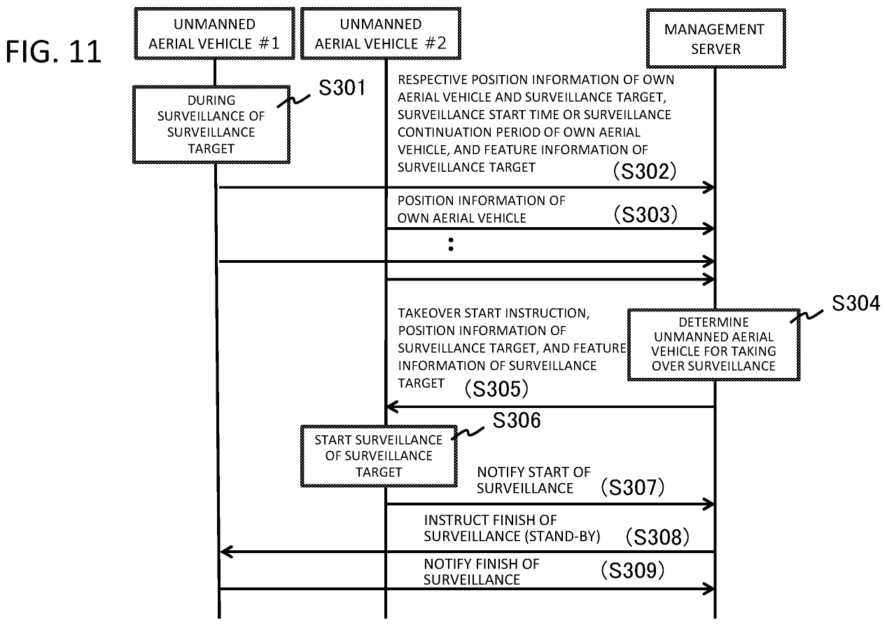

Subsequently, a description will be given about operations for surveilling the surveillance target by the unmanned aerial vehicle(s) 500 and the management server 100 that operate as mentioned above. FIG. 11 is a sequence diagram illustrating overall operations of the first exemplary embodiment of the present invention. It is assumed that in FIG. 11, as an initial state, an instruction for an unmanned aerial vehicle #1 is performed, so that surveillance of the surveillance target is being performed (step S301).

As explained in step S002 in FIG. 8, the unmanned aerial vehicle #1 that is surveilling the surveillance target transmits the following information to the management server 100 at predetermined time intervals (step S302):

position information of an own aerial vehicle and position information of the surveillance target;

a surveillance start time or a surveillance continuation period; and

feature information (amount) of the surveillance target.

As explained in step S004 in FIG. 8, an unmanned aerial vehicle #2 during stand-by for the surveillance transmits, to the management server 100, position information of an own aerial vehicle to the management server 100 at predetermined time intervals (step S303).

As explained in steps S202 to S203 in FIG. 10, the management server 100 determines an unmanned aerial vehicle for taking over the surveillance of the surveillance target if the surveillance continuation period by a certain unmanned aerial vehicle has passed the prescribed period (step S304). It is assumed herein that the management server 100 has selected the unmanned aerial vehicle #2 as a takeover destination.

Then, the management server 100 transmits the following information to an unmanned aerial vehicle #2 and instructs start of the surveillance of the surveillance target (step S305):

a takeover start instruction;

position information of the surveillance target; and

feature information of the surveillance target.

The unmanned aerial vehicle #2 that has received the instruction starts surveillance of the surveillance target, based on the position information and the feature information of the surveillance target that have been received from the management server 100 (step S306). Then, the unmanned aerial vehicle #2 notifies the start of the surveillance of the surveillance target to the management server 100 (step S307).

The management server 100 that has received the notification of the start of the surveillance from the unmanned aerial vehicle #2 instructs the unmanned aerial vehicle #1 to finish the surveillance of the surveillance target (to transition to a stand-by state for the surveillance) (step S308). The unmanned aerial vehicle #1 that has received the instruction finishes the surveillance of the surveillance target based on the instruction that has been received from the management server 100, and notifies the finish of the surveillance of the surveillance target to the management server 100 (step S309).

Then, a rule for determining, by the management server 100, the unmanned aerial vehicle for performing the surveillance in the above-mentioned step S203 in FIG. 10 and the above-mentioned step S304 in FIG. 11 will be described by depicting one example.

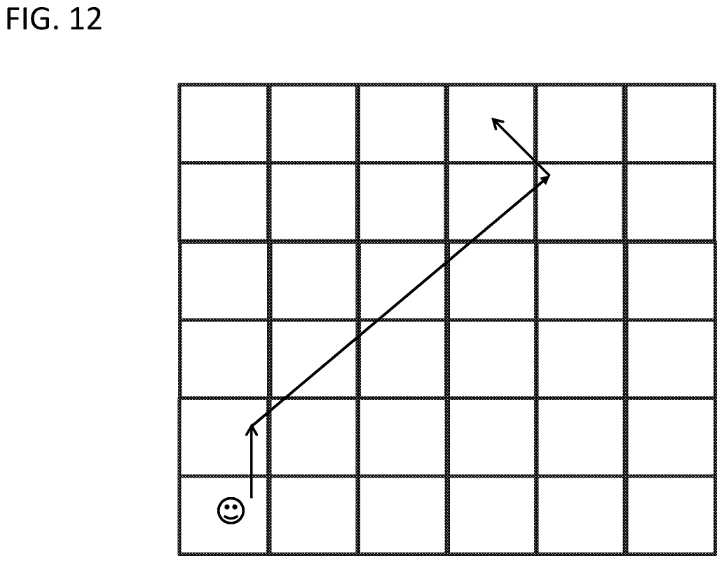

The description will be given, assuming that the surveillance target moves within a surveillance area represented by a 6×6 grid, as illustrated in FIG. 12, for example. The movement path of this surveillance target may be provided from an outside, or may be a path that has been predicted by the management server 100, based on the information received from an unmanned aerial vehicle(s) 500.

The takeover destination determination part 104 of the management server 100 selects an unmanned aerial vehicle that is located in a position suitable for the surveillance of the surveillance target at that time, based on information indicating that the surveillance target in FIG. 12 will move. As the one example, the takeover destination determination part 104 may select an unmanned aerial vehicle having a shortest distance between the position of the surveillance target and the unmanned aerial vehicle.

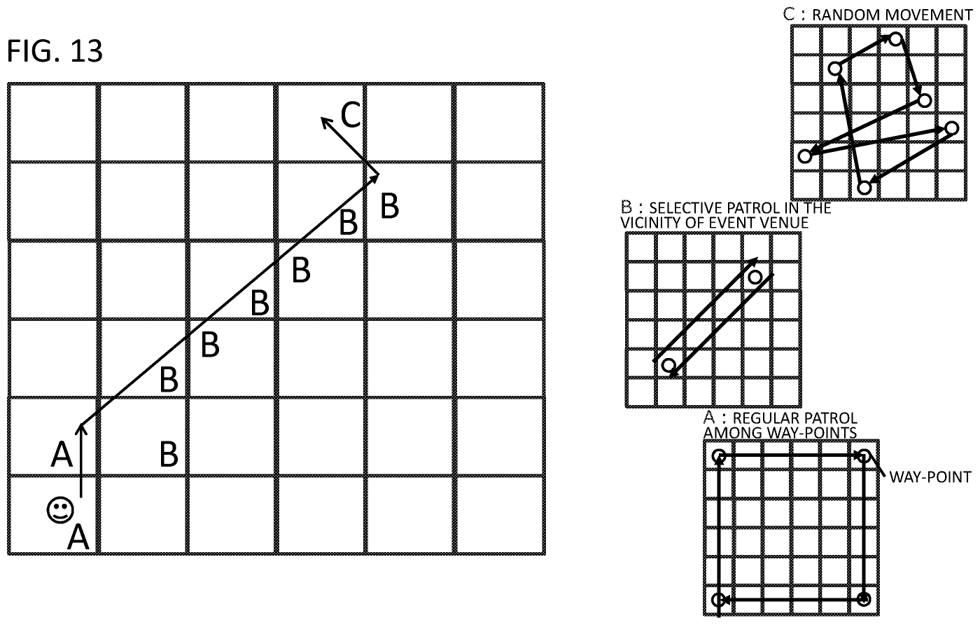

FIG. 13 illustrates examples of selecting the unmanned aerial vehicle(s) for the surveillance of the surveillance target in FIG. 12. In the examples in FIG. 13, the takeover destination determination part 104 of the management server 100 first requests an unmanned aerial vehicle A that patrols through (or among) way-points to surveil the surveillance target. Then, when the unmanned aerial vehicle A is anticipated to become apart from the surveillance target, the takeover destination determination part 104 of the management server 100 then selects an unmanned aerial vehicle B that intensively patrols in the vicinity of an event site and requests the unmanned aerial vehicle B to surveil the surveillance target. Then, when the unmanned aerial vehicle B is anticipated to become apart from the surveillance target, the takeover destination determination part 104 of the management server 100 subsequently selects an unmanned aerial vehicle C on a moving path passing-by in the vicinity of the pertinent position, and requests the unmanned aerial vehicle C to surveil the surveillance target. If the prescribed period has passed during the surveillance by the unmanned aerial vehicle B, the takeover destination determination part 104 may naturally select a different unmanned aerial vehicle to take over the surveillance of the surveillance target.

As a selection rule for the unmanned aerial vehicle, a method other than the one of selecting a nearest unmanned aerial vehicle as in FIG. 13 may also be employed. To take an example, the rule of selecting, from among the unmanned aerial vehicles having (or within) a certain distance with the surveillance target, an unmanned aerial vehicle 500 in which the movement direction of the unmanned aerial vehicle 500, the orientation of the surveillance apparatus, and so on are in an optimal state for the surveillance may be employed (selected). This makes it possible to avoid surveillance by an unmanned aerial vehicle 500 of which the surveillance target readily becomes cautious and which is positioned closest to the surveillance target.

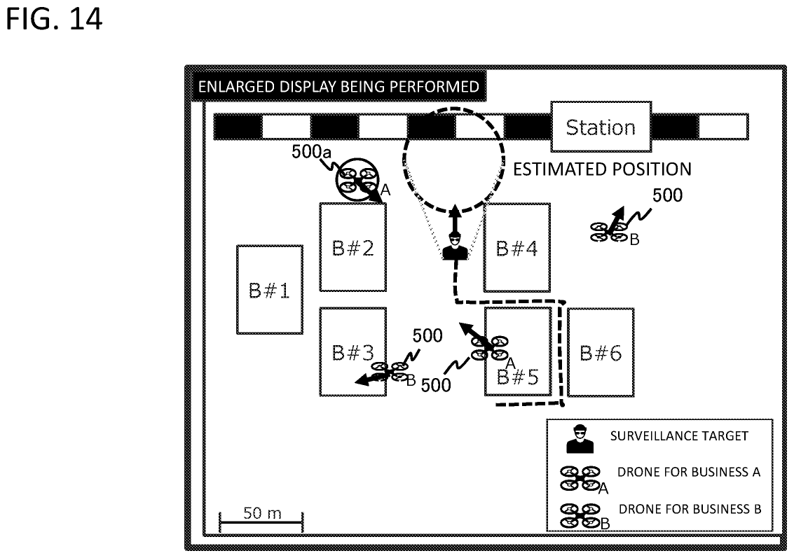

Alternatively, the above-mentioned management server 100 may provide an appropriate control screen for the operator or the like. FIG. 14 is a diagram illustrating an example of the control screen. In the example in FIG. 14, a surveillance target and a movement trajectory of a surveillance target are indicated by a broken line, and positions and moving states of the unmanned aerial vehicles to be controlled are indicated by arrow lines on a control area map. In the example in FIG. 14, an unmanned aerial vehicle 500a that is surveilling the surveillance target is enclosed by a circle (solid line) and is highlighted. In the example in FIG. 14, a predicted position of the surveillance target is indicated by a prediction circle (broken line).

It may also be so configured that when an unmanned aerial vehicle on the control screen as mentioned above is selected (clicked), a video and/or an image obtained from that unmanned aerial vehicle are displayed. Alternatively, a menu or a sub-window may be provided whereby a series of movements of the surveillance target can be grasped by joining together a video and image(s) obtained by the unmanned aerial vehicle(s) that has performed the above-mentioned takeover. By referring to the control screen as mentioned above, study of a behavior of the surveillance target in the future and measures coping with (consideration of) the behavior of the surveillance target in the future is facilitated. Naturally, the example in FIG. 14 illustrates just an example, and various modifications can be added to display forms of the map, the surveillance target and the unmanned aerial vehicles on the map.

As described above, according to the first exemplary embodiment of the present invention, it becomes possible to surveil the surveillance target with the configuration that is hard to be noticed by the surveillance target. In the above-mentioned exemplary embodiment, the description has been given, assuming that the number of the unmanned aerial vehicles that simultaneously perform the surveillance of the surveillance target is one. It may be so arranged that the surveillance is instructed to a plurality of the unmanned aerial vehicles and takeover to a plurality of the unmanned aerial vehicles is also performed in principle.

### Second Exemplary Embodiment

Subsequently, a description will be given about a second exemplary embodiment in which a search function when an unmanned aerial vehicle 500 has lost sight of a surveillance target (hereinafter referred to as a “search loss” including a case where the surveillance target has changed his clothes or the like to deceive the unmanned aerial vehicle and a case where the unmanned aerial vehicle has noticed that the unmanned aerial vehicle was surveilling a wrong surveillance target) is added. Since basic configuration and operations are the same as those in the first exemplary embodiment, the description will be given, centering on a difference of this exemplary embodiment from the first exemplary embodiment.

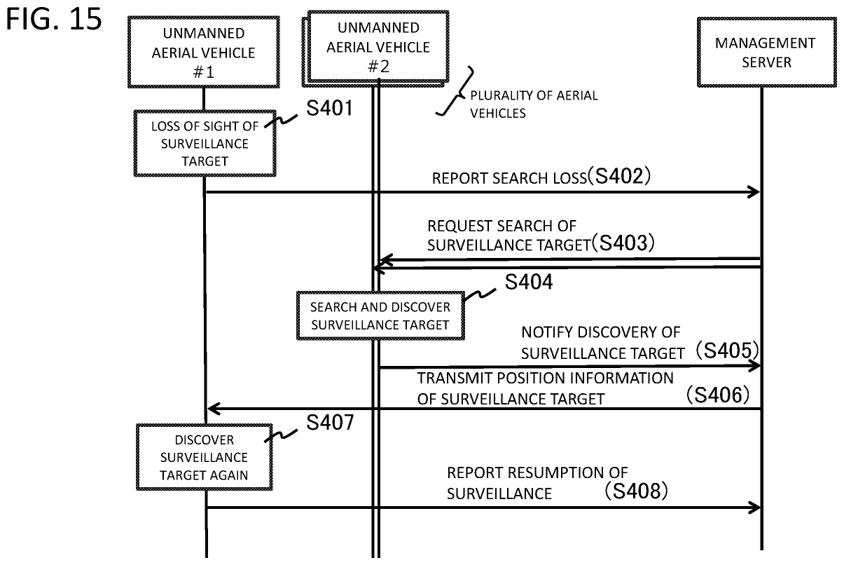

FIG. 15 is a sequence diagram for explaining the function added in the second exemplary embodiment of the present invention. Referring to FIG. 15, if an unmanned aerial vehicle #1 notices that the unmanned aerial vehicle #1 has lost sight of a surveillance target (step S401), the unmanned aerial vehicle #1 reports a search loss to a management server 100 (step S402). Information of a position (search loss position) and a time (search loss time) or feature information when the unmanned aerial vehicle #1 has last confirmed the surveillance target may be included in this report (search loss report).

The management server 100 that has received the search loss report selects one or more unmanned aerial vehicles 500 based on the information of the position where the unmanned aerial vehicle #1 has last confirmed the surveillance target, and transmits a search request for the surveillance target to each of these one or more unmanned aerial vehicles (step S403). This search request for the surveillance target includes the above-mentioned information of the position and feature information obtained when the unmanned aerial vehicle #1 has last confirmed the surveillance target, in addition to feature information of the surveillance target. With respect to the one or more unmanned aerial vehicles 500 that are selected in step S403, a method of selecting the one or more unmanned aerial vehicles within a predetermined range can be employed, based on the search loss position of the unmanned aerial vehicle #1, the transmission position of the search loss report of the unmanned aerial vehicle #1, the position of the surveillance target that is grasped on the side of the management server, the estimated position of the surveillance target, and so on.

Each of the unmanned aerial vehicles 500 that has received the search request for the surveillance target performs search for the surveillance target based on the feature information of the surveillance target included in the search request for the surveillance target (step S404). In the example in FIG. 15, it is assumed that an unmanned aerial vehicle(s) #2 has discovered the surveillance target as a result of the search for the surveillance target.

The unmanned aerial vehicle(s) #2 that has discovered the surveillance target notifies the discovery of the surveillance target to the management server 100 (step S405). This notification includes position information indicating the position of the surveillance target that has been discovered.

The management server 100 that has received the position information of the surveillance target transmits the position information of the surveillance target to an unmanned aerial vehicle #1, and requests again surveillance of the surveillance target (step S406). If the unmanned aerial vehicle #1 discovers the surveillance target (step S407) again, the unmanned aerial vehicle #1 notifies, to the management server 100, that the unmanned aerial vehicle #1 has discovered the surveillance target and resumed the surveillance (step S408).

As described above, according to this exemplary embodiment, it becomes possible to accommodate the case where the unmanned aerial vehicle has lost sight of the surveillance target due to change of the clothes by the surveillance target, disguising, or intentional disappearance from the field of view of the unmanned aerial vehicle, or the like.

In the above-mentioned exemplary embodiment, the description has been given, assuming that the management server 100 selects the one or more unmanned aerial vehicles 500 based on the information of the position where the unmanned aerial vehicle #1 has last confirmed the surveillance target. However, the configuration may also be so changed that the management server 100 broadcasts the search request for the surveillance request to all the unmanned aerial vehicles under control. In this case as well, the information of the position where the unmanned aerial vehicle #1 has last confirmed the surveillance target may be included in the search request for the surveillance target. By doing so, it becomes possible for each unmanned aerial vehicle to perform the search again, centering on the position where the unmanned aerial vehicle #1 has last confirmed the surveillance target.

In the above-mentioned exemplary embodiment, the management server 100 instructs the unmanned aerial vehicle #1 to resume the surveillance. However, when a positional relationship between the unmanned aerial vehicle #1 and the surveillance target is not appropriate as in a state where the surveillance target has greatly moved or the like, the procedure may transition to step S203 of the flowchart in FIG. 10, and an unmanned aerial vehicle for performing takeover may be selected.

### Third Exemplary Embodiment

Subsequently, a description will be given to a third exemplary embodiment in which a function, whereby an unmanned aerial vehicle 500 voluntarily requests cancellation of surveillance by an own aerial vehicle, is added. Since basic configuration and operations are the same as those in the first exemplary embodiment, the description will be given, centering on a difference of this exemplary embodiment from the first exemplary embodiment.

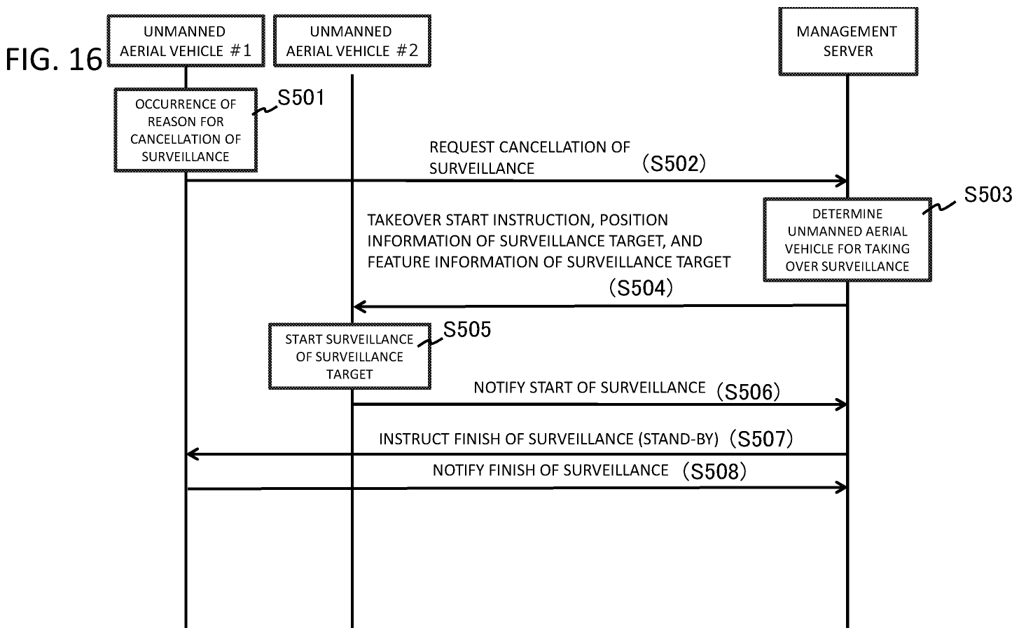

FIG. 16 is a sequence diagram for explaining the function added in the third exemplary embodiment of the present invention. Referring to FIG. 16, if any reason why surveillance of a surveillance target being surveilled should be canceled occurs (step S501), an unmanned aerial vehicle #1 transmits a surveillance cancellation request (surveillance finish request) to a management server 100 (step S502). Information of a position (search loss position) where the unmanned aerial vehicle #1 has last confirmed the surveillance target and the reason why the surveillance of the surveillance target should be cancelled may be included in this surveillance cancellation request (surveillance finish request).

As the reason why the surveillance of the surveillance target should be cancelled, the following reasons may be considered:

falling of a battery capacity below a predetermined value;

an abnormality of hardware such as a surveillance apparatus;

occurrence of a reason for not having been able to continue the surveillance, such as receipt of an instruction to move to a different area from the operator of the unmanned aerial vehicle;

an inappropriate positional relationship with the surveillance target caused by backlight, congestion in the sky, or the like; or

a case where the surveillance has been noticed by the surveillance target.

Whether or not the surveillance has been noticed by the surveillance target can be detected based on a case where the number of times that the surveillance target looks back at/looks at the own aerial vehicle has exceeded a predetermined number of times, a case where a period of time during which the surveillance target has looked at the own aerial vehicle has exceeded a predetermined period of time, or an operation, such as sudden running of the surveillance target, which can be grasped from a surveillance apparatus 503.

The management server 100 that has received the surveillance cancellation request (surveillance finish request) determines an unmanned aerial vehicle for taking over the surveillance of the surveillance target (step S503). It is assumed herein that the management server 100 has selected an unmanned aerial vehicle #2, as a takeover destination.

Then, the management server 100 transmits the following information to the unmanned aerial vehicle #2, and instructs start of surveillance of the surveillance target (step S504):

an instruction to start the takeover;

position information of the surveillance target; and

feature information (amount) of the surveillance target.

The unmanned aerial vehicle #2 that has received the instruction starts the surveillance of the surveillance target, based on the position information and the feature information of the surveillance target that have been received from the management server 100 (step S505). Then, the unmanned aerial vehicle #2 notifies the start of the surveillance of the surveillance target to the management server 100 (step S506).

The management server 100 that has received the notification of the start of the surveillance from the unmanned aerial vehicle #2 instructs the unmanned aerial vehicle #1 to finish the surveillance of the surveillance target (to transition to a stand-by state for the surveillance) (step S507). The unmanned aerial vehicle #1 that has received the instruction finishes the surveillance of the surveillance target, based on an instruction that has been received from the management server 100, and notifies the finish of the surveillance of the surveillance target to the management server 100 (step S508).

As described above, according to this exemplary embodiment, when a reason why the surveillance on the side of the unmanned aerial vehicle should be cancelled has occurred, it becomes possible for a different unmanned aerial vehicle to quickly take over the surveillance.

Though the above description has been given about each exemplary embodiment of the present invention, the present invention is not limited to the above-mentioned exemplary embodiments, and further modification, substitution, or adjustment can be applied within a scope not departing from the basic technical concept of the present invention. To take an example, the network configuration, the configuration of each element, the display form of each information element, or the like illustrated in each drawing are an example for helping understanding of the present invention, and are not limited to the modes illustrated in these drawings.

Finally, preferred modes of the present invention will be summarized.

[First Mode]

(See the surveillance system according to the above-mentioned first aspect).

[Second Mode]

Each of the unmanned flying objects in the above-mentioned surveillance system may transmit respective positions of an own unmanned flying object and the unmanned flying object, and the unmanned flying object selection part may select again at least one of the unmanned flying objects to which the surveillance of the surveillance target is requested, based on the position of the surveillance target and a distance between the surveillance target and each of the unmanned flying objects.

[Third Mode]

Preferably, the unmanned flying object selection part in the above-mentioned surveillance system finishes the instruction of the surveillance by the one of the flying objects when a period of the surveillance of the surveillance target by the one of the flying objects exceeds a predetermined period, and selects again a different one of the flying objects for which the surveillance is instructed.

[Fourth Mode]

Preferably, the predetermined period in the above-mentioned surveillance system is randomly determined for each time of unmanned flying object selection.

[Fifth Mode]

Preferably, when the unmanned flying object selection part in the above-mentioned surveillance system receives a search loss notification by the one of the unmanned flying objects, the unmanned flying object selection part requests a different one or more of the unmanned flying objects to search the surveillance target.

[Sixth Mode]

Preferably, when the unmanned flying object selection part in the above-mentioned surveillance system receives a request to finish the surveillance by the one of unmanned flying objects, the unmanned flying object selection part finishes the instruction of the surveillance by the one of the flying objects, and selects again different one of the flying objects to which the surveillance is instructed.

[Seventh Mode]

(See the unmanned flying object according to the above-mentioned second aspect).

[Eighth Mode]

(See the surveillance method according to the above-mentioned third aspect).

[Ninth Mode]

A program configured to cause a computer comprising an unmanned flying object information management part configured to store information on each of a plurality of unmanned flying objects including a predetermined flying pattern of each of the unmanned flying objects, each of the unmanned flying objects including a surveillance apparatus and being configured to move in a predetermined flying pattern, the surveillance method comprising the processes of:

selecting one of the unmanned flying objects to which surveillance of a surveillance target is requested, based on a predetermined switching condition and information received from each of the unmanned flying objects; and

instructing the selected unmanned flying object to surveil the surveillance target by transmitting identification information of the surveillance target to the selected unmanned flying object.

The above-mentioned seventh to ninth modes can be developed into the second to sixth modes, like the first mode.

The following modes are also possible in the disclosure of this application.

### Solution Measures

A surveillance system comprising two or more unmanned aerial vehicles, a surveillance apparatus mounted on each of the two or more unmanned aerial vehicles, and a management server, wherein the (each) unmanned aerial vehicle(s) transmits position information of an own aerial vehicle and position information of a surveillance target and a tracking start time or a tracking continuation period of the own aerial vehicle to the management server via a communication network, and

the management server selects one of the two or more unmanned aerial vehicles for taking over surveillance, based on the information (such as the above-mentioned position information) obtained from the unmanned aerial vehicle (that is tracking the surveillance target), and notifies the selection to the unmanned aerial vehicle.

### Effect

Since tracking continuation becomes possible while a plurality of drones suitably take over a surveillance mission (under a situation where a lot of drones perform respective missions in the sky), it becomes difficult for a surveillance target person to notice the surveillance, and a possibility that the surveillance target person will take an action of escaping from the surveillance is reduced.

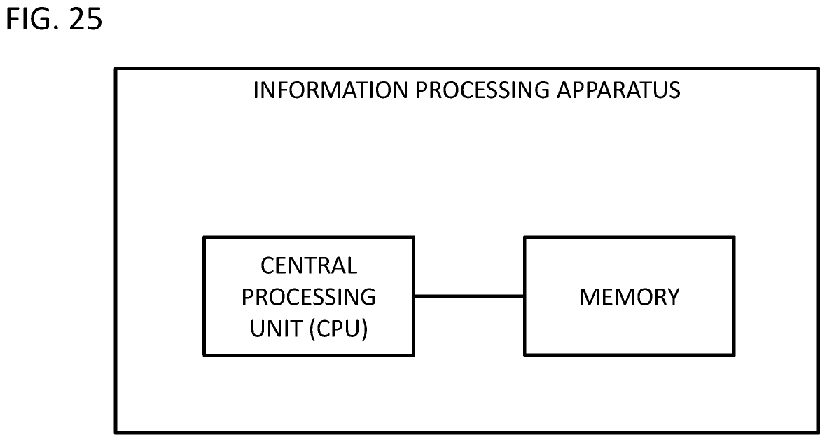

FIG. 25 is a block diagram illustrating a configuration of an information processing apparatus. An analysis server according to each exemplary embodiment may include the information processing apparatus illustrated in the above-mentioned drawing. The information processing apparatus includes a central processing unit (CPU: Central Processing Unit) and a memory. The information processing apparatus may implement a part or all of the functions of each part included in the management server by execution of a program stored in the memory by the CPU.

Mode 1

A surveillance system configured to continuously track a surveillance target while at least two or more unmanned aerial vehicles take turns in the tracking, comprising:

a plurality of unmanned aerial vehicles;

a surveillance apparatus provided with each of the plurality of aerial vehicles; and

a management server that is connected to the plurality of aerial vehicles via a communication network, wherein

the surveillance apparatus transmits position information of an own aerial vehicle and position information of the surveillance target, a tracking start time or a tracking continuation period of the own aerial vehicle to the management server via the communication network, and the management server selects one of the plurality of unmanned aerial vehicles for subsequently performing the tracking, based on the position information of the plurality of unmanned aerial vehicles and the position information of the surveillance target, and notifies the selection to the unmanned aerial vehicle.

Mode 2

The surveillance system according to Mode 1, wherein

each of the plurality of unmanned aerial vehicle includes:

a radio IF;

the surveillance apparatus;

a tracking target position information acquisition part;

an own position information acquisition part;

a time management part;

a flying control part; and

a data transmitting/receiving part.

Mode 3

The surveillance system according to Mode 1 or 2, wherein the management server includes:

an NW IF;

a data transmitting/receiving part;

a time management part;

an unmanned aerial vehicle information management part;

a tracking target information management part; and

a takeover destination determination part.

Mode 4

The surveillance system according to any one of Modes 1 to 3, wherein the management server randomly selects the unmanned aerial vehicle for subsequently performing the tracking from among one or more of the unmanned aerial vehicles that are positioned within a prescribed distance from the surveillance target, based on the position information of the plurality of unmanned aerial vehicles and the position information of the surveillance target.

Mode 5

The surveillance system according to any one of Modes 1 to 4, wherein the management server randomly determines a time when the tracking is to be subsequently taken over.

Modifications and adjustments of each exemplary embodiment or each example are possible within the scope of the overall disclosure (including the claims) of the present invention and based on the technical concept of the present invention. Various combinations and selections of various disclosed elements (including each element in each claim, each element in each exemplary embodiment and each example, each element in each drawing, and the like) are possible within the range of the disclosure of the present invention. That is, the present invention naturally includes various variations and modifications that could be made by those skilled in the art according to the overall disclosure including the claims and the technical concept. With respect to a numerical value range described herein in particular, an arbitrary numerical value and a small range included in the numerical value range should be construed to be specifically described even unless otherwise explicitly described.

### REFERENCE SIGNS LIST

10A unmanned flying object (entity) information management part
20A unmanned flying object selection part
30A surveillance instruction part
100 management server
101 unmanned aerial vehicle information management part
102 surveillance target information storage part
103 time management part
104 takeover destination determination part
105 data transmitting/receiving part
106, 505 radio interface (radio IF)
500, 500a unmanned aerial vehicle(s)
501 surveillance target position information acquisition part
502 own position information acquisition part
503 surveillance apparatus
504 data transmitting/receiving part
506 time management part
507 flying control part

What is claimed is:

1. A surveillance system, comprising:
an unmanned flying object information management part configured to store information, on each of a plurality of unmanned flying objects, including a predetermined flying pattern of each of the unmanned flying objects, each of the unmanned flying objects including a surveillance apparatus and being configured to move in the predetermined flying pattern;
an unmanned flying object selection part configured to select at least one of the unmanned flying objects to which surveillance of a surveillance target is requested, based on a predetermined switching condition and information received from each of the unmanned flying objects; and
a surveillance instruction part configured to instruct the selected unmanned flying object(s) to surveil the surveillance target by transmitting identification information of the surveillance target to the selected unmanned flying object(s).

2. The surveillance system according to claim 1, wherein
the unmanned flying object(s) transmits respective positions of an own unmanned flying object and the surveillance target, and
the unmanned flying object selection part selects again at least one of the unmanned flying objects to which the surveillance of the surveillance target is requested, based on the position of the surveillance target and a distance between the surveillance target and the unmanned flying object(s).

3. The surveillance system according to claim 1, wherein
the unmanned flying object selection part finishes the instruction of the surveillance by the one of the flying objects when a period of the surveillance of the surveillance target by the one of the flying objects exceeds a predetermined period, and selects again a different one of the flying objects for which the surveillance is instructed.

4. The surveillance system according to claim 3, wherein
the predetermined period is randomly determined for each time of unmanned flying object selection.

5. The surveillance system according to claim 1, wherein
when the unmanned flying object selection part receives a request to finish the surveillance by the one of unmanned flying objects, the unmanned flying object selection part finishes the instruction of the surveillance by the one of the flying objects, and selects again different one of the flying objects to which the surveillance is to be instructed.

6. The surveillance system according to claim 1, wherein
when the unmanned flying object selection part receives a search loss notification from one of the unmanned flying objects, the unmanned flying object selection part requests a different one or more of the unmanned flying objects to search the surveillance target.

7. An unmanned flying object comprising:
a surveillance apparatus configured to receive an instruction from a surveillance instruction part of a surveillance system and transmits information on a surveillance target to the surveillance system,
wherein the surveillance system comprises:
an unmanned flying object information management part configured to store information, on each of the unmanned flying objects including a predetermined flying pattern of each of the unmanned flying objects, each of the unmanned flying objects including the surveillance apparatus and being configured to move in the predetermined flying pattern;
an unmanned flying object selection part configured to select at least one of the unmanned flying objects to which surveillance of the surveillance target is to be requested, based on a predetermined switching condition and information received from the unmanned flying object(s); and
a surveillance instruction part configured to instruct the selected unmanned flying object(s) to surveil the surveillance target by transmitting identification information of the surveillance target to the selected unmanned flying object(s).

8. The unmanned flying object according to claim 7, wherein
the unmanned flying object transmits, to the surveillance system, respective positions of the surveillance target and an own unmanned flying object; and
the unmanned flying object prompts the unmanned flying object selection unit of the surveillance system to select again one of the unmanned flying objects for which the surveillance of the surveillance target is requested, based on a position of the surveillance target and a distance between the surveillance target and the unmanned flying object(s).

9. The unmanned flying object according to claim 7, wherein
when a surveillance period of the surveillance target exceeds a predetermined period, the unmanned flying object transmits a surveillance finish request to the surveillance system and prompts the surveillance system to select again different one of the unmanned flying objects for which the surveillance is instructed.

10. A surveillance method performed by a computer, wherein the computer comprises
an unmanned flying object information management part configured to store information on each of a plurality of unmanned flying objects including a predetermined flying pattern of each of the unmanned flying objects, each of the unmanned flying objects including a surveillance apparatus and being configured to move in the predetermined flying pattern,
the computer performing processings comprising:
selecting at least one of the unmanned flying objects to which surveillance of a surveillance target is to be requested, based on a predetermined switching condition and information received from the unmanned flying object(s); and
instructing the selected unmanned flying object(s) to surveil the surveillance target by transmitting identification information of the surveillance target to the selected unmanned flying object(s).

11. The surveillance method according to claim 10, wherein
the unmanned flying object(s) transmits respective positions of an own unmanned flying object and the surveillance target, and
the unmanned flying object selection part selects again at least one of the unmanned flying objects to which the surveillance of the surveillance target is requested, based on the position of the surveillance target and a distance between the surveillance target and the unmanned flying object(s).

12. The surveillance method according to claim 10, wherein
the unmanned flying object selection part finishes the instruction of the surveillance by the one of the flying objects when a period of the surveillance of the surveillance target by the one of the flying objects exceeds a predetermined period, and selects again a different one of the flying objects for which the surveillance is instructed.

13. The surveillance method according to claim 12, wherein
the predetermined period is randomly determined for each time of unmanned flying object selection.

14. The surveillance method according to claim 10, wherein
when the unmanned flying object selection part receives a request to finish the surveillance by the one of unmanned flying objects, the unmanned flying object selection part finishes the instruction of the surveillance by the one of the flying objects, and selects again different one of the flying objects to which the surveillance is to be instructed.

15. The surveillance method according to claim 10, wherein
when the unmanned flying object selection part receives a search loss notification from one of the unmanned flying objects, the unmanned flying object selection part requests a different one or more of the unmanned flying objects to search the surveillance target.
